(19) United States
(12) Patent Application Publication
(10) Pub. No.: US 2024/0370615 A1
(43) Pub. Date: Nov. 7, 2024

(54) METHODS AND APPARATUS TO IMPLEMENT THERMAL GRADIENT PROJECTION AND DESIGN FEEDBACK ON POWER DELIVERY

(71) Applicant: Intel Corporation, Santa Clara, CA (US)

(72) Inventors: Lei Jiang, Camas, WA (US); Daniel Pantuso, Portland, OR (US); Satish Sethuraman, Bangalore (IN); Kambiz Komeyli, Portland, OR (US); Jeffrey Hicks, Banks, OR (US)

(21) Appl. No.: 18/345,972

(22) Filed: Jun. 30, 2023

(51) Int. Cl. G06F 30/327

(52) U.S. Cl. CPC G06F 30/327; G06F 2119/06; G06F 2119/08; G06F 2119/12

(57) ABSTRACT

Systems, apparatus, articles of manufacture, and methods are disclosed An apparatus comprising: programmable circuitry; interface circuitry; and instructions to program the programmable circuitry to: map one or more circuit layouts to a hardware description language model of a circuit to generate a power density map for the circuit; estimate a temperature gradient between a first area of the circuit and a second area of the circuit based on the power density map; identify the first area as a hotspot based on the temperature gradient exceeding a threshold value; and compensate for a predicted timing change due to the temperature gradient.

### FIELD OF THE DISCLOSURE

This disclosure relates generally to circuit design and, more particularly, to methods and apparatus to implement thermal gradient projection and design feedback on power delivery.

### BACKGROUND

Circuit design (e.g., integrated circuit design, system-on-chip (SOC) design, printed circuit board design, etc.) often involves the use of computer aided design (CAD) software packages commonly referred to as electronic design automation (EDA) tools. EDA tools help design both the logical or functional aspects of a circuit as well as the physical layout of components to achieve the logical or functional aspects within specified constraints (e.g., timing requirements, circuit efficiency, power consumption, etc.).

### BRIEF DESCRIPTION OF THE DRAWINGS

FIG. 1 is a block diagram of an example environment in which an example thermal gradient based design optimization circuitry operates to implement thermal gradient projection and design feedback on power delivery.

FIG. 2 is a block diagram of an example implementation of the thermal gradient design circuitry of FIG. 1.

FIG. 3 illustrates an example of generation of a fine scale powermap at different resolutions.

FIG. 4 is an illustration of thermal maps generated by the thermal gradient design circuitry.

FIG. 5 is a graph illustrating example results of two thermal analyses of a circuit.

FIG. 6 is a flowchart representative of example machine readable instructions and/or example operations that may be executed, instantiated, and/or performed by example programmable circuitry to implement the thermal gradient design circuitry of FIG. 2.

FIG. 7 is a flowchart representative of example machine readable instructions and/or example operations that may be executed, instantiated, and/or performed by example programmable circuitry to identify a hotspot.

FIG. 8 is a flowchart representative of example machine readable instructions and/or example operations that may be executed, instantiated, and/or performed by example programmable circuitry to manage a timing path associated with a hotspot.

FIG. 9 is a block diagram of an example processing platform including programmable circuitry structured to execute, instantiate, and/or perform the example machine readable instructions and/or perform the example operations of FIGS. 6-8 to implement the thermal gradient design circuitry of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Electronic design automation (EDA) tools are used for design, generation, simulation, and analysis of electronic circuits. EDA tools include functionality perform one or more of design a circuit, simulate the behavior of the circuit, and modify the physical layout of the designed circuit prior to manufacturing.

Temperature significantly influences the performance of electronic components of a circuit. Thus, when simulating the behavior of a circuit, designers may use EDA tools to carefully manage and optimize a circuit's thermal response. Through management of the thermal response, EDA tools allow designers to ensure that circuits will operate in a manner consistent with their design constraints.

To manage the thermal response of the circuit, conventional EDA tools utilize time-consuming simulations for thermal analysis. While such simulations may assess the thermal behavior of some electronic circuits, as electronic circuits become more complex and densely packed, such simulations become increasingly computationally expensive. Furthermore, thermal analysis is often an iterative process. Designers repeatedly perform simulations, analyze the results, and make design modifications to improve the thermal performance. In many instances, designers must run simulations multiple times to assess the impact of their design changes and optimize their designs. The iterative nature of thermal analysis compounds the time-consuming nature of the thermal analysis and design process.

Thermal hotspots are areas of a circuit with temperatures that are greater than other areas of a circuit. Accurate hotspot identification involves time and resource-intensive simulations to capture a detailed temperature distribution across a circuit. Some simulations visualize hotspots on a power density map, which is a graphical representation of power dissipation across the circuit. By examining the power map, designers can identify areas with high power density.

With modern backside power delivery processes, transistors often experience higher thermal gradients due to increased thermal resistance from the dielectric material used in signal routing layers (e.g., in the path of main heat dissipation). Such gradients can reduce reliability of timing and potential degradation of performance. By examining the power map, designers can evaluate the power distribution and identify areas where power dissipation exceeds safe limits, enabling appropriate measures to ensure the reliability and longevity of the circuit. However, as with other EDA simulations, generation of a power map is exceedingly computationally expensive.

Example methods and apparatus disclosed herein provide an integration for EDA tools to efficiently generate power maps and estimate thermal gradients of a circuit based on power distribution and metal grid information from the interconnects (e.g., frontside and/or backside interconnects) of a circuit. Based on a determined thermal gradient, examples disclosed herein can guide power density design fixes (e.g., spreading high power circuit elements away from each other) or thermal spreading improvement (e.g., modification of interconnect layers). Thus, disclosed examples provide improved management of circuit temperature distribution, hotspots, and heat dissipation, enabling designers to make informed decisions, improve reliability, optimize thermal management strategies, and prevent potential failures due to excessive temperatures.

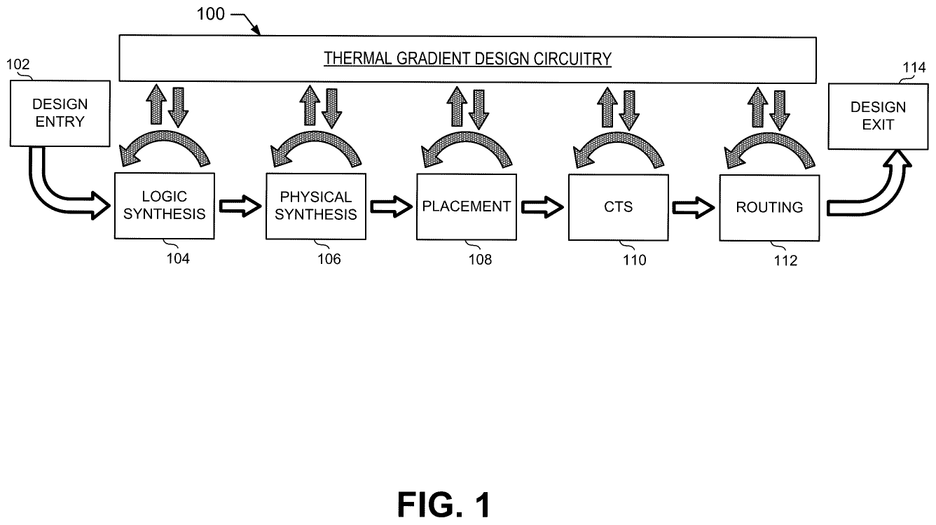

FIG. 1 is an example block diagram illustrating a thermal gradient design circuitry 100 to improve the iterative process of circuit design. In the illustration of FIG. 1, the example thermal gradient design circuitry 100 is integrated into the circuit design process at each step. However, in some examples, the thermal gradient design circuitry 100 may interaction with (and thus enhance) fewer than all the stages of the circuit design process.

As shown in the illustrated example, the circuit design process begins with an initial design entry 102 that serves as an input to a logic synthesis stage 104 implemented by an EDA tool. In some examples, the design entry 102 is based on and/or corresponds to a register-transfer level (RTL) description of the design. In some examples, the thermal gradient design circuitry 100 may generate an RTL description of the design and/or perform a thermal analysis based on an RTL design that is provided to the thermal gradient design circuitry 100.

After completion of one iteration of the logic synthesis stage 104, the output design state data is checked against target optimization goals or thresholds for the output and associated quality metrics associated with design specification requirements. If the target optimization goals or thresholds and/or the quality metrics are not satisfied the logic synthesis stage 104 of the process is repeated. In some examples, subsequent iterations are based on changes to the initial RTL description for the circuit design. In some cases, changes to the RTL description are based on what was learned from one or more iterations (e.g., the most recent iteration) through the logic synthesis stage 104. Such changes may be driven by the thermal gradient design circuitry 100.

In other cases, changes may be made independent of the output of the previous iteration(s) of the logic synthesis stage 104. For instance, in some examples, a circuit designer may begin with multiple slightly different RTL descriptions of a desired circuit design with each being tested by being processed or run through the logic synthesis stage 104. Once all the target optimization goals, thermal thresholds, timing metrics, and/or any other quality metrics are satisfied (e.g., the output of the logic synthesis is fully optimized), the process advances to the next stage.

In the illustrated example of FIG. 1, a physical synthesis stage 106 is the next stage. Thus, in this example, the final output of the logic synthesis stage 104 is used as an input to the physical synthesis stage 106. The physical synthesis stage 106 is repeated as many times as needed until associated optimization goals and quality metrics are satisfied before advancing to a placement stage 108. The thermal gradient design circuitry 100 may analyze the physical synthesis stage results and provide recommendations for thermal management.

Likewise, a placement stage 108 is repeated as many times as needed until associated optimization goals and quality metrics are satisfied before advancing to a clock tree synthesis (CTS) stage 110, which is then iterated through as many times as needed before advancing to a routing stage 112 that is iterated until optimization is achieved to produce a final output 114 for the construction phase. The thermal gradient design circuitry 100 may analyze and/or guide placement, CTS, and/or routing of the circuit prior to design exit. In some examples, a single EDA tool is a software package suite with functionality to perform or implement two or more of the stages 104, 106, 108, 110, 112 of the circuit design process. In some examples, a separate EDA tool is used to implement each stage 104, 106, 108, 110, 112 in the circuit design process, with the thermal gradient design circuitry 100 acts as an orchestrator to facilitate the generation of a design based on separate EDA tools.

As shown in FIG. 1, the thermal gradient design circuitry 100 interacts with one or more (e.g., all) of the stages 104-112 to generate an improved output of the design exit stage 114 for a given input of the design entry stage 112.

In some examples, the final output 114 of the process shown in FIG. 1 is used as an input for the sign-off phase of circuit design, which can include multiple stages that need to be separately iterated through in a manner similar to the construction phase detailed above. In such an example, thermal gradient design circuitry 100 can interact with and improve each corresponding phase of the circuit design and validation.

Example processes associated with thermal management disclosed herein that may be executed, modified, or improved by thermal gradient design circuitry 100 include layout verification, design rule checking (DRC), electrical topology checking, mapping one or more circuit layouts to a hardware description language model of a circuit to generate a power density map for the circuit, estimating a temperature gradient between a first area of the circuit and a second area of the circuit based on the power density map, identifying the first area as a hotspot based on the temperature gradient exceeding a threshold value, and compensating for a predicted timing change due to the temperature gradient. Some examples predict a thermal response of the first area of the circuit based a thermal spreading kernel that is process dependent, including a metal pattern on the back-side of the first area. Some examples predict the thermal response of the first area of the circuit based on a local temperature rise at the transistor layer, an interconnect (e.g., a front-side interconnect) thermal resistance, and the power density map. Performing any of these operations in association with even a single iteration through a single stage in the construction phase cannot practically be performed in the human mind and often take a computer system several hours and up to several days (or more) depending on the size and complexity of the circuit being designed as well as the nature and/or capacity of the computer system that is executing the EDA tool. Having to repeat each example step multiple times means that each stage can take considerable amounts of time that can span across multiple days or weeks. Needing to iterate through each stage for this amount of time results in the overall time to complete the design of a circuit extending for many weeks if not months.

As noted above, example processes disclosed herein extend EDA tool thermal management capabilities in association with any stage in circuit design. Each stage in circuit design is a computationally intensive process that involves the design, placement, and analysis of thousands, if not millions (or more), of circuit components. Thermal analysis of said components is even more computationally intensive. Thus, impractical and impossible to carry out examples disclosed herein example in the human mind or by a human with the aid of pen and paper, a calculator, etc.

In some examples, particular iterations through one or more stages in the construction process may supplemented by the thermal gradient design circuitry 100. That is, the thermal gradient design circuitry 100 may modify design parameters to test and see how the changes will affect the thermal aspects of the resulting output of the EDA tool. This information may be used by the thermal gradient design circuitry 100 to further modify the circuit design. As described above, without the thermal gradient design circuitry 100 can obtain this information without running computationally expensive simulations, which can take hours, if not days or weeks to complete. Having to wait days, or even hours to learn a thermal design will need to be modified is inefficient and costly. Thus, the thermal gradient design circuitry 100 can interact with one or more (e.g., all) stages 104-112 to provide enhanced thermal mapping capabilities and improve the functioning of circuits.

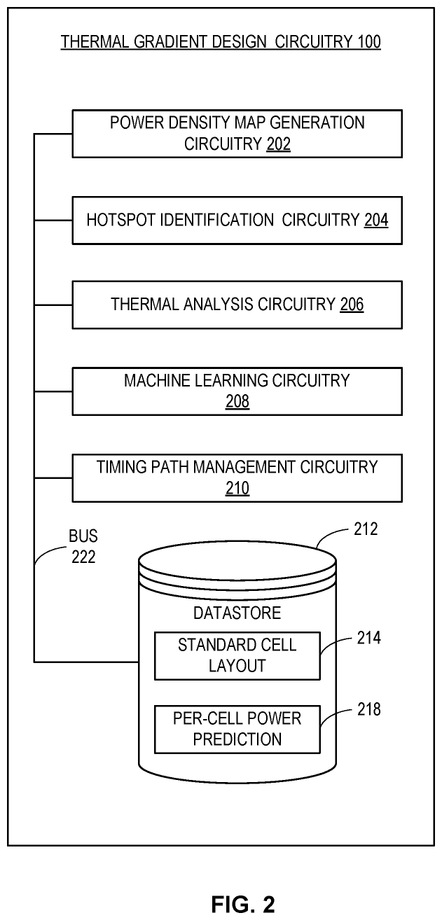

FIG. 2 is a block diagram of an example implementation of the thermal gradient design circuitry 100 of FIG. 1 to implement thermal gradient projection and design feedback. The thermal gradient design circuitry 100 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the thermal gradient design circuitry 100 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The thermal gradient design circuitry 100 includes example power density map generation circuitry 202. The power density map generation circuitry 202 may generate a powermap from a design database. Powermaps are not commonly included in power simulation tools, yet powermaps may be an important part of thermal analysis. By mapping one or more circuit layouts to a hardware description language model of a circuit to generate a power density map for the circuit (e.g., merging a layout database that contains standard cell placements and the per-cell power prediction based on an FSDB file (a binary format for simulation output generated by EDA logic simulation tools) of a workload and RTL design), the power density map generation circuitry 202 can generate a powermap at one or more resolutions.

In some examples, the power density map generation circuitry 202 determines power characteristics of one or more cells (e.g., standard cells) in a circuit design. Power estimation can be based on various factors such as cell characteristics, operating conditions, and activity factors derived from the netlist or other sources. In some examples, the power density map generation circuitry 202 can provide a visualization of an amount of power associated with each cell for display via a visual interface.

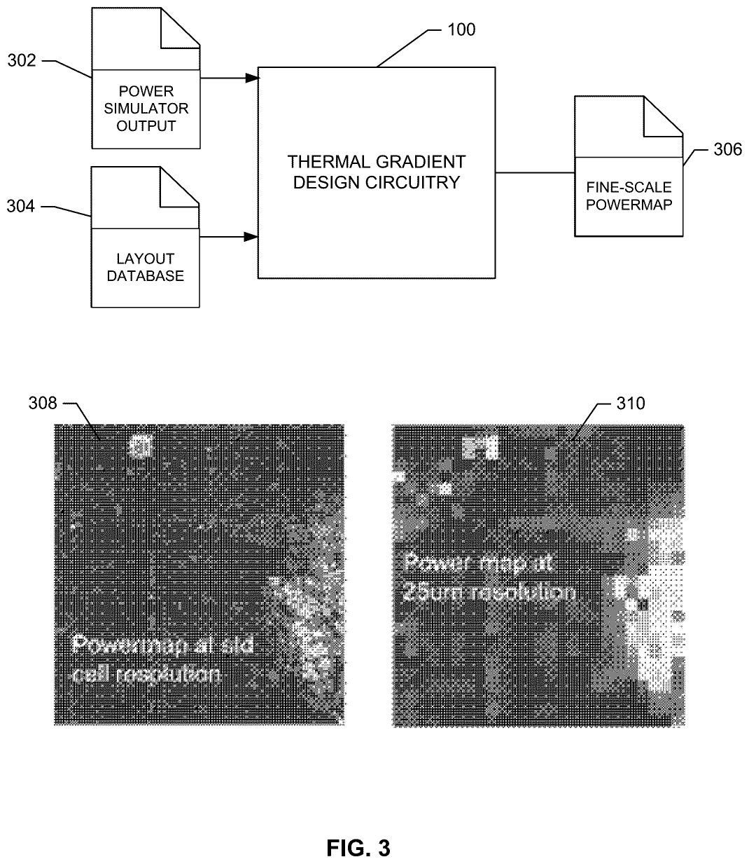

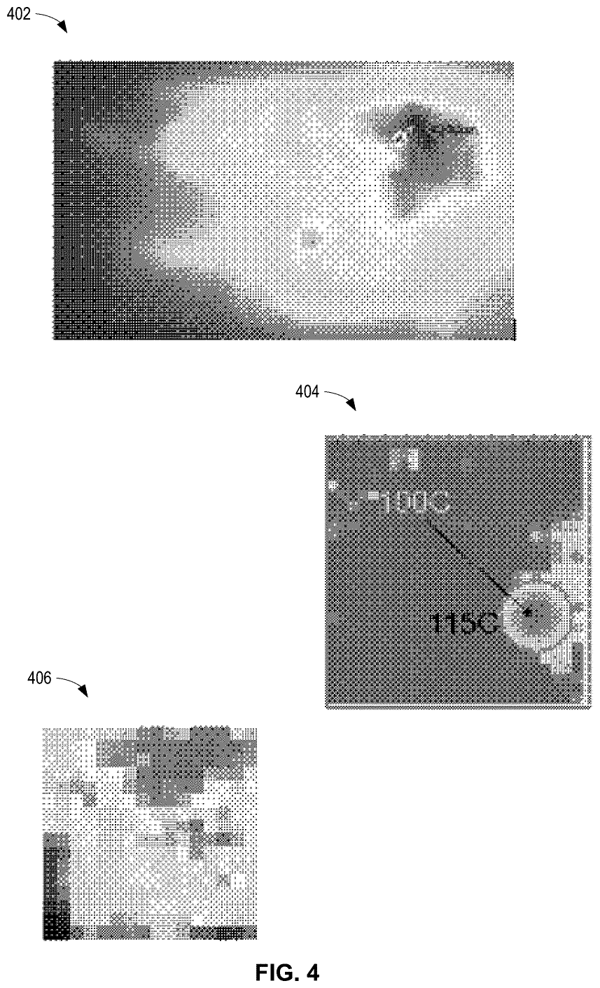

In some examples, the power density map generation circuitry 202 may calculate the power distribution across the integrated circuit layout based on power dissipation values assigned to the cells. To determine the power distribution, the power density map generation circuitry 202 may analyze the proximity of cells, their interconnection, the netlist/connectivity information (e.g., to determine how power is distributed and flows through the cells), etc. Then, power values associated with one or more regions of the circuit may be represented using colors corresponding to power levels. As can be seen in the examples of FIGS. 3 and 4, high power density regions, where power dissipation is significant, may be represented with warmer colors or higher intensity levels, indicating areas of potential thermal concern or increased power consumption. Lower power density regions may be depicted with cooler colors or lower intensity levels.

In some examples, the power density map generation circuitry 202 may map one or more circuit layouts to a hardware description language model of a circuit to generate a power density map for the circuit. For example, the power density map generation circuitry 202 may map a circuit layout to a hardware description language (HDL) model by correlating elements of the circuit layout with the HDL model.

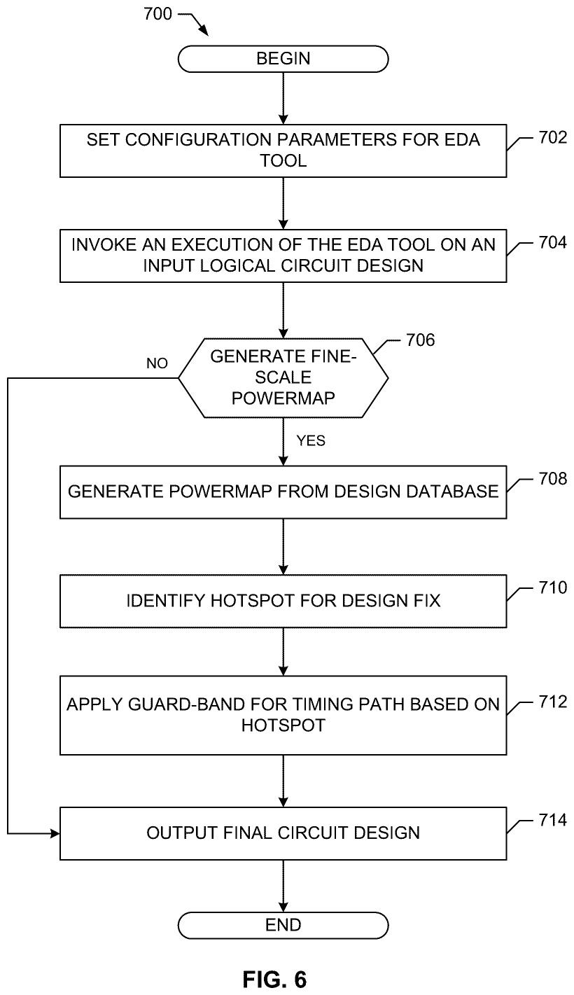

In some examples, the thermal gradient design circuitry 100 and/or the power density map generation circuitry 202 may be integrated natively into an EDA tool and generate a power density map and/or a thermal map. In such a scenario an output may be an extension of power-density oriented optimization for placement and routing steps. In some examples, the power density map generation circuitry 202 may guide placement of thermal cooling structures. In some examples, the power density map generation circuitry 202 is instantiated by programmable circuitry executing power density map generation instructions and/or configured to perform operations such as those represented by the flowchart(s) of FIGS. 6-8.

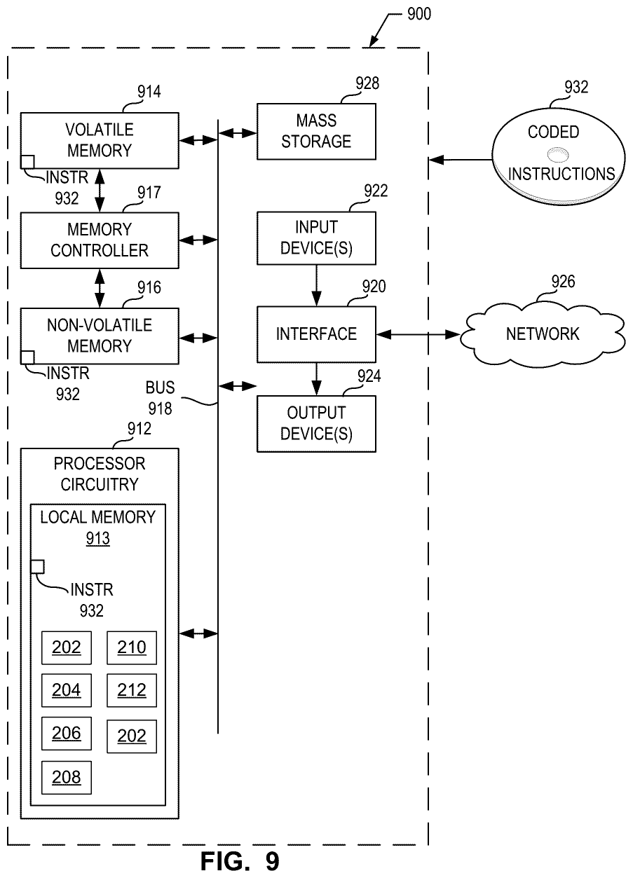

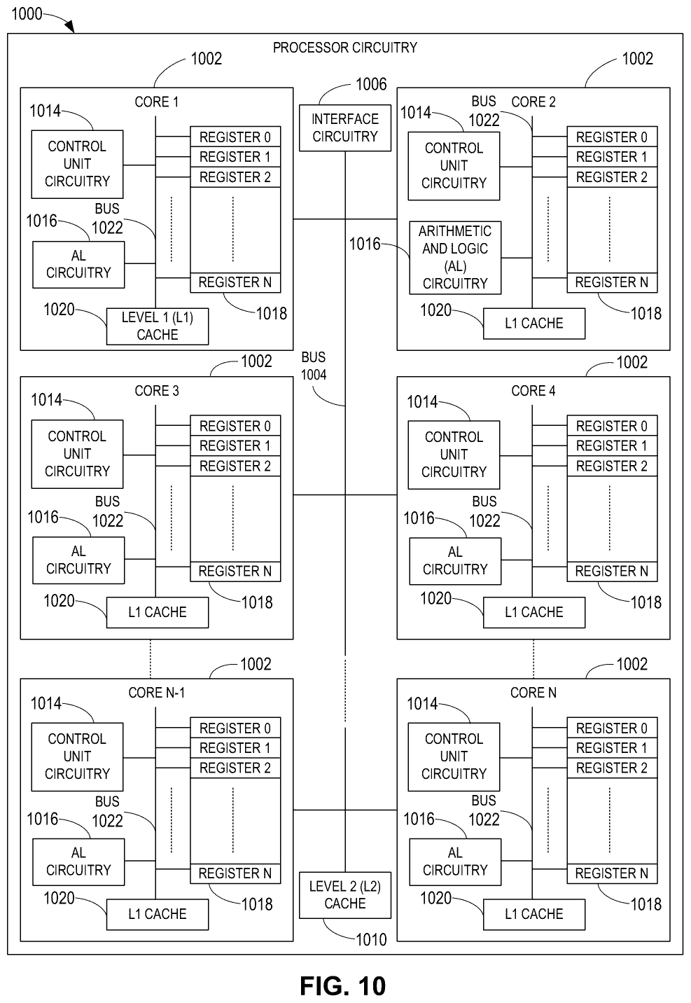

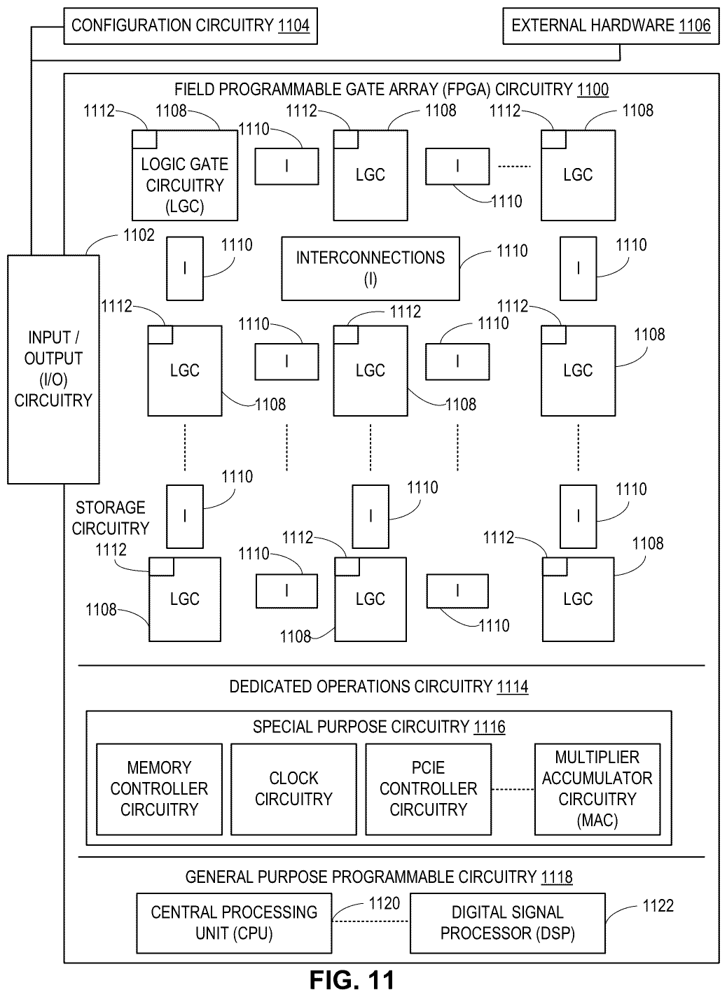

In some examples, the thermal gradient design circuitry 100 includes means generating a power density map. For example, the means for generating may be implemented by power density map generation circuitry 202. In some examples, the power density map generation circuitry 202 may be instantiated by programmable circuitry such as the example programmable circuitry 912 of FIG. 9. For instance, the power density map generation circuitry 202 may be instantiated by the example microprocessor 1000 of FIG. 10 executing machine executable instructions such as those implemented by at least blocks 706 and 708 of FIG. 6. In some examples, power density map generation circuitry 202 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the power density map generation circuitry 202 may be instantiated by any other combination of hardware, software, and/or firmware. For example, the power density map generation circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The thermal gradient design circuitry 100 includes the hotspot identification circuitry 204. The hotspot identification circuitry 204 may identify a first area of a as a hotspot based on a temperature gradient exceeding a threshold value. As used herein “threshold” is expressed as data such as a numerical value represented in any form, that may be used by processor circuitry as a reference for a comparison operation.

A hot spot is an area of a semiconductor that, in operation, exceeds the acceptable thermal characteristics of the device (e.g., exceeds a threshold temperature difference between the area and a second area). Hotspots are a significant concern, as temperatures of hot spots can cause unexpected operating characteristics. For example, the middle of hot spot can be so high as to cause local melting and destruction of the materials of the semiconductor.

A heat map generated by the power density map generation circuitry 202 can be used to identify a hotspot based on a threshold value. For example, the hotspot identification circuitry 204 can identify areas of a semiconductor that exceed a threshold temperature. The identification may be based on a temperature difference (e.g., between a first area and a second area of a circuit). For example, when the temperature difference exceeds a threshold value (e.g., distinguish between normal temperature regions and potential hotspots) the hotspot identification circuitry 204 can categorize the first area as a hotspot. In some examples, the hotspot identification circuitry 204 is instantiated by programmable circuitry executing hotspot identification instructions and/or configured to perform operations such as those represented by the flowchart(s) of FIGS. 6-8.

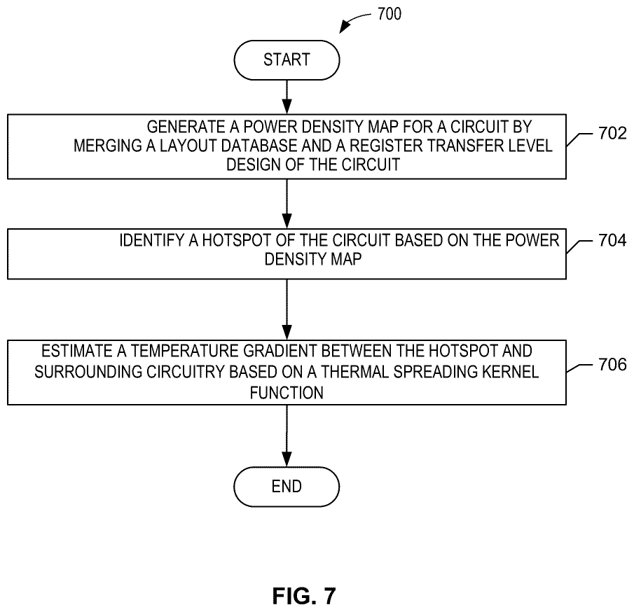

In some examples, the thermal gradient design circuitry 100 includes means for identifying a hotspot. For example, the means for identifying may be implemented by hotspot identification circuitry 204. In some examples, the hotspot identification circuitry 204 may be instantiated by programmable circuitry such as the example programmable circuitry 912 of FIG. 9. For instance, the hotspot identification circuitry 204 may be instantiated by the example microprocessor 1000 of FIG. 10 executing machine executable instructions such as those implemented by at least blocks 710 of FIG. 7. In some examples, hotspot identification circuitry 204 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the hotspot identification circuitry 204 may be instantiated by any other combination of hardware, software, and/or firmware. For example, the hotspot identification circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The thermal gradient design circuitry 100 includes example thermal analysis circuitry 206. The thermal analysis circuitry 206 can abstract the backside metal grid and front-side routing layers in terms of their effect on thermal dissipation. The thermal analysis circuitry 206 may include a model for thermal response that captures process stack details and layout parameters.

For example, thermal analysis circuitry 206 may develop a model of a circuit that includes placement, connectivity, and metal density of the circuit. In some examples, the thermal analysis circuitry 206 can use the model described in Equation 1 below (e.g., alternatively to than using finite-element models to resolve three-dimensional geometric features) to identify a hotspot. Thus, the thermal analysis circuitry 206 can produce, via Equation 1 below, an effective thermal conductivity that approximates a full three dimensional finite element model simulation. Thus, the thermal analysis circuitry 206 can approximate the accuracy of a full FEM simulation with a relatively short runtime (e.g., less than a minute vs. hundreds of hours on many CPUs in parallel with the FEM approach).

In some examples, the thermal analysis circuitry 206 can determine the thermal response of any arbitrary logic block with existing metal routing based on Equation 1 below:

T=Σₖ₌₀ⁿRxPden(x,y)xG(k,x,y) Equation 1

In Equation 1, T represents local temperature rise at the transistor layer, R is the effective map for an interconnect (e.g., a front-side interconnect) thermal resistance, Pden is the power density map, and G(k, x, y) is a thermal spreading kernel that is process dependent, including effects such as back-side metal patterns. Taking these effects and power density into account over n pixels (with k as an index for the summation), the thermal analysis circuitry 206 can estimate the gradient of temperature rise on any design, with process details abstracted in the formulation of the R and G(k, x, y) functions.

In some examples, the thermal analysis circuitry 206 is instantiated by programmable circuitry executing thermal spreading kernel analysis instructions and/or configured to perform operations such as those represented by the flowchart(s) of FIGS. 6-8.

In some examples, the thermal gradient design circuitry 100 includes means for performing a thermal analysis of a circuit. For example, the means for performing may be implemented by thermal analysis circuitry 206. In some examples, the thermal analysis circuitry 206 may be instantiated by programmable circuitry such as the example programmable circuitry 912 of FIG. 9. For instance, the thermal analysis circuitry 206 may be instantiated by the example microprocessor 1000 of FIG. 10 executing machine executable instructions such as those implemented by at least blocks 714 of FIG. 7. In some examples, the thermal analysis circuitry 206 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the thermal analysis circuitry 206 may be instantiated by any other combination of hardware, software, and/or firmware. For example, the thermal analysis circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The thermal gradient design circuitry 100 includes machine learning circuitry 208. The machine learning circuitry 208 may extend the thermal analysis capabilities of the thermal gradient design circuitry 100. As used herein, a model is a set of instructions and/or data that may be ingested, processed, interpreted and/or otherwise manipulated by processor circuitry to produce a result. Often, a model is operated using input data to produce output data in accordance with one or more relationships reflected in the model. The model may be based on training data.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In some examples disclosed herein, ML/AI models are trained using gradient descent. However, any other training algorithm may additionally or alternatively be used. In examples disclosed herein, training is performed until an acceptable amount of error is achieved. In examples disclosed herein, training is performed locally at the device that executes an EDA tool. Training is performed using hyperparameters that control how the learning is performed (e.g., a learning rate, a number of layers to be used in the machine learning model, etc.). In some examples retraining may be performed. Such re-training may be performed in response to new data generated by an EDA tool.

Training is performed using training data. In examples disclosed herein, the training data originates from output of an EDA tool that includes thermal gradient design circuitry 100. Once training is complete, the model is deployed for use as an executable construct that processes an input and provides an output based on the network of nodes and connections defined in the model. The model may be stored in the datastore 212, for example. The model may then be executed by the machine learning circuitry 208.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model. In some examples, the machine learning circuitry 208 is instantiated by programmable circuitry executing machine learning instructions and/or configured to perform operations such as those represented by the flowchart(s) of FIGS. 6-8.

In some examples, the thermal gradient design circuitry 100 includes means for executing a machine learning model on thermal data. For example, the means for executing may be implemented by thermal analysis circuitry 206. In some examples, the thermal analysis circuitry 206 may be instantiated by programmable circuitry such as the example programmable circuitry 912 of FIG. 9. For instance, the thermal analysis circuitry 206 may be instantiated by the example microprocessor 1000 of FIG. 10 executing machine executable instructions such as those implemented by at least blocks 702-706 of FIG. 7. In some examples, the machine learning circuitry 208 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the condition determination circuitry __00 may be instantiated by any other combination of hardware, software, and/or firmware. For example, the condition determination circuitry __00 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The thermal gradient design circuitry 100 includes the timing path management circuitry 210. The timing path management circuitry 210 can manage timing paths (e.g., micron scale timing paths) based on a gradient between a hotspot (e.g., a first area) and a second area (e.g., a non-hotspot, a cool spot). For example, the timing path management circuitry 210 may identify a temperature difference (e.g., 5 C, 15 C, 100 C, etc.) between a first area and a second area. Then, based on the temperature difference, identify the first area and/or the second area as the hotspot. The timing path management circuitry 210 may, based on the temperature exceeding the threshold, manage a device threshold voltage, manage a supply voltage, manage a frequency of operation, manage and/or generate a timing path.

The timing path management circuitry 210 may identify one or more paths that cannot meet a timing requirement. For example, the timing path management circuitry 210 may identify a hotspot as a root cause of why a path is failing setup timing. The timing path management circuitry 210 can also manage timing paths using thermal gradient information to design and/or assign a guard band for a timing path of different margins and spans. In some examples, the configuration control circuitry 210 is instantiated by programmable circuitry executing configuration control instructions and/or configured to perform operations such as those represented by the flowchart(s) of FIGS. 6-8.

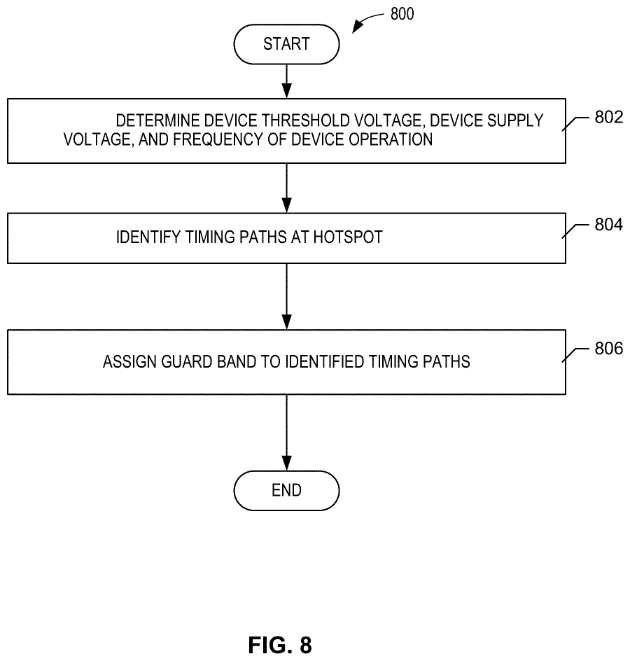

In some examples, the thermal gradient design circuitry 100 includes means for managing timing of a circuit. For example, the means for managing may be implemented by timing path management circuitry 210. In some examples, the timing path management circuitry 210 may be instantiated by programmable circuitry such as the example programmable circuitry 912 of FIG. 9. For instance, the timing path management circuitry 210 may be instantiated by the example microprocessor 1000 of FIG. 10 executing machine executable instructions such as those implemented by at least blocks 802-806 of FIG. 8. In some examples, the timing path management circuitry 210 may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the timing path management circuitry 210 may be instantiated by any other combination of hardware, software, and/or firmware. For example, the timing path management circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The thermal gradient design circuitry 100 includes the datastore 212. In the example of FIG. 2, the datastore 212 includes a standard cell layout 214 and a per-cell power prediction data 218. The standard cell layout 214 and a per-cell power prediction data 218 may be provided to any of the power density map generation circuitry 202, the hotspot identification circuitry 204, the thermal analysis circuitry 206, the machine learning circuitry 208, or the timing path management circuitry 210 via a bus 222. The bus 222 may also

While an example manner of implementing the thermal gradient design circuitry 100 of FIG. 1 is illustrated in FIG. 2, one or more of the elements, processes, and/or devices illustrated in FIG. 2 may be combined, divided, re-arranged, omitted, eliminated, and/or implemented in any other way. Further, the power density map generation circuitry 202, hotspot identification circuitry 204, thermal analysis circuitry 206, machine learning circuitry 208, timing path management circuitry 210, and/or, more generally, the example thermal gradient design circuitry 100 of FIG. 2, may be implemented by hardware alone or by hardware in combination with software and/or firmware. Thus, for example, any of the power density map generation circuitry 202, hotspot identification circuitry 204, thermal analysis circuitry 206, machine learning circuitry 208, timing path management circuitry 210, and/or, more generally, the example thermal gradient design circuitry 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example thermal gradient design circuitry 100 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the thermal gradient design circuitry 100 of FIG. 2 and/or representative of example operations which may be performed by programmable circuitry to implement and/or instantiate the thermal gradient design circuitry 100 of FIG. 2, are shown in FIGS. 6-8. The machine readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-8, many other methods of implementing the example thermal gradient design circuitry 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-8 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 illustrates an example of generation of a fine scale powermap 306 at different resolutions. The fine-scale powermap 306 is generated based on a power simulator output 302 and a layout database 304. The power simulator output 302 and a layout database 304 can be provided to the thermal gradient design circuitry 100 to generate the fine-scale powermap 306.

In this example, the powermap 306 is a two-dimensional grid or layout of the circuit, with each grid point corresponding to an area on the circuit. The powermap 306 is shown at two resolutions: a standard resolution powermap 308 and a detailed resolution powermap 310. The standard resolution powermap 308 and the full scale powermap 310 are both generated by the thermal gradient design circuitry 100. In both the standard resolution powermap 308 and the fine-scale resolution powermap 310, the brightness of each grid point in the powermap corresponds to the amount of power dissipated at that particular location. High power dissipation areas are represented with lighter colors (e.g., white), while lower power regions are depicted with darker colors (e.g., black). In some examples, the powermaps 308 and/or 310 may be colored with warmer colors (e.g., orange, red, pink) representing areas of relatively high heat, and cooler colors (e.g., blue, purple,) representing areas of relatively lower heat.

FIG. 4 is an illustration of thermal maps generated by the thermal gradient design circuitry 100. In the example of FIG. 4, the thermal gradient design circuitry 100 generates a heat map 402. The hotspot identification circuitry 204 then identifies a hotspot 404, which a user enlarges to identify characteristics of the hotspot at 406.

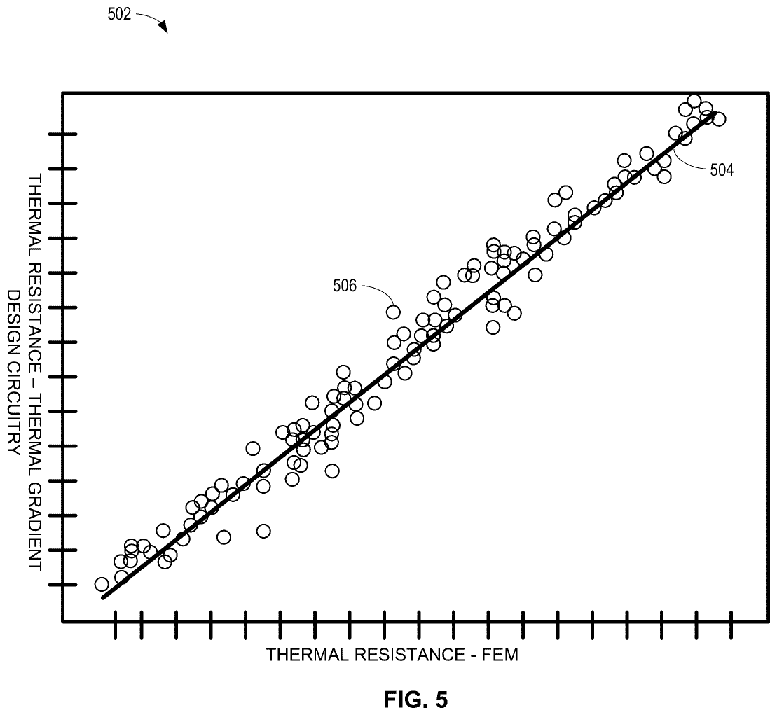

FIG. 5 is a graph illustrating example results of two thermal analyses of a circuit. One example is provided on each axis. Each axis corresponds to a thermal resistance value (e.g., thermal rise for power density). The horizontal axis is illustrative of a thermal resistance calculation from a finite element model. The vertical axis is illustrative of a thermal resistance calculation from the thermal gradient design circuitry 100 (e.g., Equation 1, a compact model, etc.). In this example, the graph 502 illustrates a 25 micron window matrix of a partition (e.g., a 40×40 grid). Then, in the graph 502, each data point is a comparison of the temperature determined by the thermal gradient design circuitry 100 compared to a temperature determined by a full finite element method (FEM) simulation. A 45 degree line 504 shows what would be a perfect match between the FEM simulation and the thermal gradient design circuitry 100. As illustrated by the graph 502, thermal gradient design circuitry 100 executing Equation 1 can perform similarly to a computationally expensive FEM simulation.

FIG. 6 is a flowchart representative of example machine readable instructions and/or example operations 600 that may be executed, instantiated, and/or performed by programmable circuitry to perform thermal analysis. The example machine-readable instructions and/or the example operations 700 of FIG. 7 begin at block 702, at which the example power density map generation circuitry 202 can set configuration parameters for an EDA tool.

At block 704, the example power density map generation circuitry 202 invokes an execution of the EDA tool on an input logical circuit design. At block 706, the example power density map generation circuitry 202 determines if the thermal gradient design circuitry 100 is to generate a fine-scale powermap. If so, the instructions continue at block 708. Otherwise, the instructions continue at block 714.

At block 708, the example power density map generation circuitry 202 generates a powermap from a design database. At block 710, the example hotspot identification circuitry 204 identifies a hotspot for a design fix. At block 712, the example timing path management circuitry 210 applies a guard-band for timing path based on hotspot. At block 714, the example thermal gradient design circuitry 100 outputs a final circuit design. The instructions end.

FIG. 7 is a flowchart representative of example machine readable instructions and/or example operations 700 that may be executed, instantiated, and/or performed by programmable circuitry to identify a hotspot on a powermap. The instructions 700 begin at block 702, at which the power density map generation circuitry 202 generates a power density map for a circuit by merging a layout database and a register transfer level design of the circuit.

At block 704, the thermal analysis circuitry 206 identifies a hotspot of the circuit based on the power density map. At block 706, the thermal analysis circuitry 206 estimates a temperature gradient between the hotspot and surrounding circuitry based on a thermal spreading kernel function. The instructions end.

FIG. 8 is a flowchart representative of example machine readable instructions and/or example operations 800 that may be executed, instantiated, and/or performed by programmable circuitry to manage a timing path that includes a hotspot. At block 802, the timing path management circuitry 210 determine device threshold voltage, device supply voltage, and frequency of device operation. At block 804, the timing path management circuitry 210 identify timing paths at hotspot. At block 806, the timing path management circuitry 210 assigns a guard band to identified timing paths. The instructions end.

FIG. 9 is a block diagram of an example programmable circuitry platform 900 structured to execute and/or instantiate the example machine-readable instructions and/or the example operations of FIGS. 6-8 to implement the thermal gradient design circuitry 100 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements power density map generation circuitry 202, hotspot identification circuitry 204, thermal analysis circuitry 206, machine learning circuitry 208, timing path management circuitry 210.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 932, which may be implemented by the machine readable instructions of FIGS. 6-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6-8 to effectively instantiate the circuitry of FIG. 2 as logic circuits to perform operations corresponding to those machine readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 6-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-8. As such, the FPGA circuitry 1100 may be configured and/or structured to effectively instantiate some or all of the operations/functions corresponding to the machine readable instructions of the flowchart(s) of FIGS. 6-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine readable instructions of FIGS. 6-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine readable instructions of FIGS. 6-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 6-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIG. 6-8, and/or an ASIC may be configured and/or structured to perform third operation(s)/function(s) corresponding to a third portion of the machine readable instructions represented by the flowcharts of FIGS. 6-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

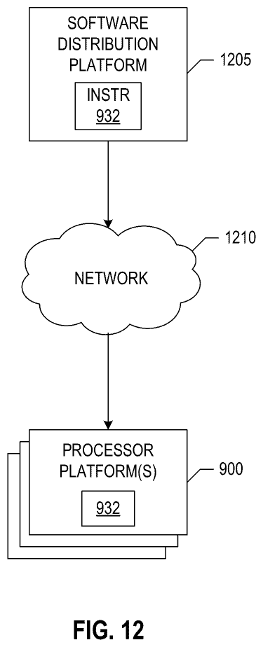

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 6-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIG. 6-8, may be downloaded to the example programmable circuitry platform 900, which is to execute the machine readable instructions 932 to implement the thermal gradient design circuitry 100. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed to implement thermal gradient projection and design feedback on backside power delivery process. Disclosed systems, apparatus, articles of manufacture, and methods improve the efficiency of using a computing device by improving thermal management of circuits. Some examples provide an improved generation of a thermal map of electronic circuits using EDA tools. By incorporating thermal analysis capabilities, disclosed examples enable designers to accurately analyze and optimize the thermal behavior of electronic circuits. This facilitates efficient thermal management, prevents overheating, and enhances the reliability and performance of electronic systems. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement thermal gradient projection and design feedback on power delivery are disclosed herein. Further examples and combinations thereof include the following:

Example 1 includes an apparatus comprising programmable circuitry, interface circuitry, and instructions to program the programmable circuitry to map a circuit layout to a hardware description language model of a circuit to generate a power density map for the circuit, estimate a temperature gradient of a first area of the circuit and a second area of the circuit based on the power density map, identify the first area as a hotspot based on the temperature gradient meeting a threshold value, and determine a predicted timing change due to the temperature gradient.

Example 2 includes the apparatus of example 1, wherein the programmable circuitry is to predict a thermal response of the first area of the circuit based a thermal spreading kernel that is process dependent, including a metal pattern on a back-side of the first area.

Example 3 includes the apparatus of example 2, wherein the programmable circuitry is further to predict the thermal response of the first area of the circuit based on a local temperature rise at a transistor layer, a front-side interconnect thermal resistance, and the power density map.

Example 4 includes the apparatus of example 1, wherein the instructions program the programmable circuitry to cause a compensation to be applied to the circuit to compensate for the predicted timing change.

Example 5 includes the apparatus of example 4, wherein to compensate for a predicted timing change includes assigning a thermal guard band to the circuit.

Example 6 includes the apparatus of example 5, wherein the programmable circuitry is to increase a guard band temperature range based on the threshold value being exceeded.

Example 7 includes the apparatus of example 1, wherein the programmable circuity is to determine a per-cell power prediction based on a register transfer level description of the circuit.

Example 8 includes the apparatus of example 1, wherein the programmable circuitry is to provide the power density map at more than one resolution.

Example 9 includes the apparatus of example 8, wherein the programmable circuitry is to adjust the resolution of the power density map based on a user input.

Example 10 includes a non-transitory computer readable medium comprising instructions that, when executed, cause a machine to map a circuit layout to a hardware description language model of a circuit to generate a power density map for the circuit, estimate a temperature gradient of a first area of the circuit and a second area of the circuit based on the power density map, identify the first area as a hotspot based on the temperature gradient meeting a threshold value, and determine a predicted timing change due to the temperature gradient.

Example 11 includes the non-transitory computer readable medium of example 10, wherein the instructions, when executed, cause the machine to predict a thermal response of the first area of the circuit based a thermal spreading kernel that is process dependent, including a metal pattern on a back-side of the first area.

Example 12 includes the non-transitory computer readable medium of example 11, wherein the instructions, when executed, cause the machine to predict the thermal response of the first area of the circuit based on a local temperature rise at a transistor layer, a front-side interconnect thermal resistance, and the power density map.

Example 13 includes the non-transitory computer readable medium of example 10, wherein the instructions, when executed, cause the machine to cause a compensation to be applied to the circuit to compensate for the predicted timing change.

Example 14 includes the non-transitory computer readable medium of example 13, wherein to compensate for a predicted timing change includes assigning a thermal guard band to the circuit.

Example 15 includes the non-transitory computer readable medium of example 14, wherein the instructions, when executed, cause the machine to increase a guard band temperature range based on the threshold value being exceeded.

Example 16 includes the non-transitory computer readable medium of example 10, wherein the instructions, when executed, cause the machine to determine a per-cell power prediction based on a register transfer level description of the circuit.

Example 17 includes the non-transitory computer readable medium of example 10, wherein the instructions, when executed, cause the machine to provide the power density map at more than one resolution.

Example 18 includes the non-transitory computer readable medium of example 17, wherein the instructions, when executed, cause the machine to adjust the resolution of the power density map based on a user input.

Example 19 includes a method comprising mapping a circuit layout to a hardware description language model of a circuit to generate a power density map for the circuit, estimating a temperature gradient of a first area of the circuit and a second area of the circuit based on the power density map, identifying the first area as a hotspot based on the temperature gradient meeting a threshold value, and determining a predicted timing change due to the temperature gradient.

Example 20 includes the method of example 19, further comprising predicting a thermal response of the first area of the circuit based a thermal spreading kernel that is process dependent, including a metal pattern on a back-side of the first area.

Example 21 includes the method of example 20, further comprising predicting the thermal response of the first area of the circuit based on a local temperature rise at a transistor layer, a front-side interconnect thermal resistance, and the power density map.

Example 22 includes the method of example 19, further comprising causing a compensation to be applied to the circuit to compensate for the predicted timing change.

Example 23 includes the method of example 22, wherein to compensate for a predicted timing change includes assigning a thermal guard band to the circuit.

Example 24 includes the method of example 23, further comprising increasing a guard band temperature range based on the threshold value being exceeded.

Example 25 includes the method of example 19, further comprising determining a per-cell power prediction based on a register transfer level description of the circuit.

Example 26 includes the method of example 19, further comprising providing the power density map at more than one resolution.

Example 27 includes the method of example 26, further comprising adjusting the resolution of the power density map based on a user input.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
programmable circuitry;
interface circuitry; and
instructions to program the programmable circuitry to:
map a circuit layout to a hardware description language model of a circuit to generate a power density map for the circuit;
estimate a temperature gradient of a first area of the circuit and a second area of the circuit based on the power density map;
identify the first area as a hotspot based on the temperature gradient meeting a threshold value; and
determine a predicted timing change due to the temperature gradient.

2. The apparatus of claim 1, wherein the programmable circuitry is to predict a thermal response of the first area of the circuit based a thermal spreading kernel that is process dependent, including a metal pattern on a back-side of the first area.

3. The apparatus of claim 2, wherein the programmable circuitry is further to predict the thermal response of the first area of the circuit based on a local temperature rise at a transistor layer, a front-side interconnect thermal resistance, and the power density map.

4. The apparatus of claim 1, wherein the instructions program the programmable circuitry to cause a compensation to be applied to the circuit to compensate for the predicted timing change.

5. The apparatus of claim 4, wherein to compensate for a predicted timing change includes assigning a thermal guard band to the circuit.

6. The apparatus of claim 5, wherein the programmable circuitry is to increase a guard band temperature range based on the threshold value being exceeded.

7. The apparatus of claim 1, wherein the programmable circuity is to determine a per-cell power prediction based on a register transfer level description of the circuit.

8. The apparatus of claim 1, wherein the programmable circuitry is to provide the power density map at more than one resolution.

9. The apparatus of claim 8, wherein the programmable circuitry is to adjust the resolution of the power density map based on a user input.

10. A non-transitory computer readable medium comprising instructions that, when executed, cause a machine to:
map a circuit layout to a hardware description language model of a circuit to generate a power density map for the circuit;
estimate a temperature gradient of a first area of the circuit and a second area of the circuit based on the power density map;
identify the first area as a hotspot based on the temperature gradient meeting a threshold value; and
determine a predicted timing change due to the temperature gradient.

11. The non-transitory computer readable medium of claim 10, wherein the instructions, when executed, cause the machine to predict a thermal response of the first area of the circuit based a thermal spreading kernel that is process dependent, including a metal pattern on a back-side of the first area.

12. The non-transitory computer readable medium of claim 11, wherein the instructions, when executed, cause the machine to predict the thermal response of the first area of the circuit based on a local temperature rise at a transistor layer, a front-side interconnect thermal resistance, and the power density map.

13. The non-transitory computer readable medium of claim 10, wherein the instructions, when executed, cause the machine to cause a compensation to be applied to the circuit to compensate for the predicted timing change.

14. The non-transitory computer readable medium of claim 13, wherein to compensate for a predicted timing change includes assigning a thermal guard band to the circuit.

15. The non-transitory computer readable medium of claim 14, wherein the instructions, when executed, cause the machine to increase a guard band temperature range based on the threshold value being exceeded.

16. The non-transitory computer readable medium of claim 10, wherein the instructions, when executed, cause the machine to determine a per-cell power prediction based on a register transfer level description of the circuit.

17. The non-transitory computer readable medium of claim 10, wherein the instructions, when executed, cause the machine to provide the power density map at more than one resolution.

18. The non-transitory computer readable medium of claim 17, wherein the instructions, when executed, cause the machine to adjust the resolution of the power density map based on a user input.

19. A method comprising:
mapping a circuit layout to a hardware description language model of a circuit to generate a power density map for the circuit;
estimating a temperature gradient of a first area of the circuit and a second area of the circuit based on the power density map;
identifying the first area as a hotspot based on the temperature gradient meeting a threshold value; and
determining a predicted timing change due to the temperature gradient.

20. The method of claim 19, further comprising predicting a thermal response of the first area of the circuit based a thermal spreading kernel that is process dependent, including a metal pattern on a back-side of the first area.

21-27. (canceled)
